(19) United States
(12) Patent Application Publication
(10) Pub. No.: US 2015/0170598 A1
(43) Pub. Date: Jun. 18, 2015

(54) METHOD OF DRIVING DISPLAY PANEL AND DISPLAY APPARATUS FOR PERFORMING THE SAME

(71) Applicant: Samsung Display Co., LTD., Yongin-City (KR)

(72) Inventors: Bong-Chool JEON, Cheonan-si (KR); Yun-Tae KIM, Seoul (KR); Choong-Hwa KIM, Seongnam-si (KR); Chae-Woo CHUNG, Cheonan-si (KR); Ki-Hyun PYUN, Gwangmyeong-si (KR); Eun-Bum PYUN, Cheonan-si (KR)

(73) Assignee: Samsung Display Co., LTD., Yongin-City (KR)

(21) Appl. No.: 14/291,474

(22) Filed: May 30, 2014

(30) Foreign Application Priority Data
Dec. 16, 2013 (KR) 10-2013-0156249

(51) Int. Cl. G09G 3/36

(52) U.S. Cl. CPC G09G 3/3696; G09G 2330/023; G09G 2320/04; G09G 2300/0452; G09G 2320/0276

(57) ABSTRACT

A method of driving a display panel includes comparing a previous frame data and a present frame data, outputting an inversion control signal of the present frame based on a result of the comparing the previous frame data and the present frame data, generating a positive pixel voltage and a negative pixel voltage based on the inversion control signal and displaying an image based on the positive pixel voltage and the negative pixel voltage.

### PRIORITY STATEMENT

This application claims priority under 35 U.S.C. §119 to Korean Patent Application No. 10-2013-0156249, filed on Dec. 16, 2013 in the Korean Intellectual Property Office KIPO, the contents of which are herein incorporated by reference in their entireties.

### BACKGROUND

1. Field

Exemplary embodiments of the present inventive concept relate to a method of driving a display panel and a display apparatus for performing the method. More particularly, exemplary embodiments of the present inventive concept relate to a method of driving a display panel improving a display quality and a display apparatus for performing the method.

2. Description of the Related Art

Generally, a liquid crystal display (“LCD”) apparatus includes a first substrate including a pixel electrode, a second substrate including a common electrode and a liquid crystal layer disposed between the first and second substrate. An electric field is generated by voltages applied to the pixel electrode and the common electrode. By adjusting an intensity of the electric field, a transmittance of light passing through the liquid crystal layer may be adjusted so that a desired image may be displayed.

A grayscale of a pixel is determined by a voltage difference between a pixel voltage applied to the pixel electrode and a common voltage applied to the common electrode. When the pixel electrode has a single polarity with respect to the common voltage, a residual DC voltage may be accumulated on liquid crystal molecules. Due to the accumulated residual DC voltage, a display quality of the display panel may be deteriorated.

To prevent the residual DC from being accumulated, a positive pixel voltage having a positive polarity with respect to the common voltage and a negative pixel voltage having a negative polarity with respect to the common voltage may be alternately applied to the pixels of the display panel in every frame. An above explained driving method is called as a frame inversion method. When positive pixel voltages are applied to all of the pixels during a first frame and negative pixel voltages are applied to all of the pixels during a second frame, a flickering may occur due to a difference of luminance between the positive pixel voltage and the negative pixel voltage which correspond to the same grayscale.

Thus, the positive pixel voltage and the negative pixel voltage may be alternately applied to the data lines of the display panel. An above explained driving method is called as a column inversion method. During a first frame, positive pixel voltages are applied to a subpixel column connected to a first data line and negative pixel voltages are applied to a subpixel column connected to a second data line. During a second frame, negative pixel voltages are applied to the subpixel column connected to the first data line and positive voltages are applied to the subpixel column connected to the second data line. However, when the pixels of the display panel are driven in the column inversion method and an image pattern is scrolled in the display panel by a width corresponding to odd pixels, the polarity of the pattern may be maintained regardless of frames so that a vertical line defect may be generated.

To prevent the vertical line defect, the positive pixel voltage and the negative pixel voltage may be alternately applied to each subpixel along the data line. An above explained driving method is called as a dot inversion method. During a first frame, a positive pixel voltage, a negative pixel voltage, a positive pixel voltage and a negative pixel voltage may be sequentially applied to a first subpixel column connected to a first data line. During a second frame, a negative pixel voltage, a positive pixel voltage, a negative pixel voltage and a positive pixel voltage may be sequentially applied to the first subpixel column connected to the first data line. However, a power consumption of the display apparatus using the dot inversion method may increase.

### SUMMARY

Exemplary embodiments of the present inventive concept provide a method of driving a display panel capable of improving a display quality of the display panel and decreasing a power consumption of a display apparatus.

Exemplary embodiments of the present inventive concept also provide a display apparatus performing the method.

In an exemplary embodiment of a method of driving a display apparatus according to the present inventive concept, the method includes comparing a previous frame data and a present frame data, outputting an inversion control signal of the present frame based on a result of the comparing the previous frame data and the present frame data, generating a positive pixel voltage and a negative pixel voltage based on the inversion control signal and displaying an image based on the positive pixel voltage and the negative pixel voltage.

In an exemplary embodiment, the inversion control signal may include an inversion mode signal. The inversion mode signal may include a column inversion mode signal and a dot inversion mode signal i. The dot inversion mode signal may include one dot inversion mode signal, two by one dot inversion mode signal, two by two dot inversion mode signal, three by one dot inversion mode signal and three by two dot inversion mode signal.

In an exemplary embodiment, when the previous frame data and the present frame data represent a moving artifact pattern, the inversion mode signal may include the dot inversion mode signal. When the previous frame data and the present frame data do not represent the moving artifact pattern, the inversion mode signal may include the column inversion mode signal.

In an exemplary embodiment, the display panel may include a non-alternating pattern in which all subpixels in a first subpixel column are connected to a data line. When a pattern between the previous frame data and the present frame data is shifted by odd number of pixels in a row direction i, the pattern may be determined as the moving artifact pattern.

In an exemplary embodiment, the comparing the previous frame data and the present frame data may compare grayscale voltages of one data line in the previous frame data and grayscale voltages of one data line in the present frame data.

In an exemplary embodiment, the display panel may include subpixel columns and subpixel rows. Each of the subpixel columns may include subpixels representing the same color. Each of the subpixel rows may sequentially include a red subpixel, a green subpixel and a blue subpixel. The comparing the previous frame data and the present frame data may compare grayscale voltages of M-th data line in the previous frame data and grayscale voltages of (M+3)-th data line in the present frame data, M being a positive integer.

In an exemplary embodiment, the display panel may include subpixel columns and subpixel rows. Each of the subpixel columns may sequentially include a red subpixel, a green subpixel and a blue subpixel. Each of the subpixel rows may include subpixels representing the same color. The comparing the previous frame data and the present frame data may compare grayscale voltages of M-th data line in the previous frame data and grayscale voltages of (M+1)-th data line in the present frame data. M is a positive integer.

In an exemplary embodiment, the inversion control signal may include a normal inverting signal having sequentially distributed high levels and low levels in a first operating mode, and a scramble inverting signal having randomly distributed high levels and low levels in a second operating mode.

In an exemplary embodiment, the outputting the inversion control signal of the present frame may include generating a scramble enable signal by comparing the previous frame data and the present frame data and selectively outputting one of the normal inverting signal and the scramble inverting signal based on the scramble enable signal.

In an exemplary embodiment, the scramble enable signal maybe generated when the previous frame data is different from the present frame data and a counter signal representing an accumulated status of polarity of the pixel voltage is unbiased.

In an exemplary embodiment, duration of the high levels and duration of the low levels may maintain to be substantially the same.

In an exemplary embodiment of a display apparatus according to the present inventive concept, the display apparatus includes an inversion controlling part, a data driver and a display panel. The inversion controlling part is configured to compare a previous frame data and a present frame data to output an inversion control signal. The data driver is configured to generate a positive pixel voltage and a negative pixel voltage based on the inversion control signal. The display panel is configured to display an image based on the positive pixel voltage and the negative pixel voltage.

In an exemplary embodiment, the inversion control signal may include an inversion mode signal. The inversion mode signal may include a column inversion mode signal and a dot inversion mode signal, the dot inversion mode signal including one dot inversion mode signal, two by one dot inversion mode signal, two by two dot inversion mode signal, three by one dot inversion mode signal and three by two dot inversion mode signal.

In an exemplary embodiment, when the previous frame data and the present frame data represent a moving artifact pattern, the inversion controlling part may be configured to output the inversion mode signal including the dot inversion mode signal. When the previous frame data and the present frame data do not represent the moving artifact pattern, the inversion controlling part may be configured to output the inversion mode signal including the column inversion mode signal.

In an exemplary embodiment, the display panel may include a non-alternating pattern in which all subpixels in a first subpixel column are connected to a data line. When a pattern between the previous frame data and the present frame data is shifted by odd number of pixels in a row direction i, the pattern may be determined as the moving artifact pattern.

In an exemplary embodiment, the inversion controlling part may compare grayscale voltages of one data line in the previous frame data and grayscale voltages of one data line in the present frame data.

In an exemplary embodiment, the inversion control signal may include a normal inverting signal having sequentially distributed high levels and low levels in a first operating mode and a scramble inverting signal having randomly distributed high levels and low levels in a second operating mode.

In an exemplary embodiment, the inversion controlling part may include a scramble signal generating part configured to generate a scramble enable signal by comparing the previous frame data and the present frame data and an inverting signal outputting part configured to selectively output one of the normal inverting signal and the scramble inverting signal based on the scramble enable signal.

In an exemplary embodiment, the scramble signal generating part may be configured to generate the scramble enable signal when the previous frame data is different from the present frame data and a counter signal representing an accumulated status of polarity of the pixel voltage is unbiased.

In an exemplary embodiment, the inverting signal outputting part may include a multiplexer, the multiplexer configured to receive the scramble enable signal as a control signal and the normal inverting signal and the scramble inverting signal as input signals and configured to output one of the normal inverting signal and the scramble inverting signal.

According to the method of driving the display panel and the display apparatus performing the method, an inversion driving of the display panel is controlled using a previous frame data and a present frame data so that a display quality of the display panel may be improved and a power consumption of the display apparatus may be decreased.

### BRIEF DESCRIPTION OF THE DRAWINGS

The above and other features and advantages of the present inventive concept will become more apparent by describing in detailed exemplary embodiments thereof with reference to the accompanying drawings, in which:

FIG. 1 is a block diagram illustrating a display apparatus according to an exemplary embodiment of the present inventive concept;

FIG. 2 is a plan view illustrating a pixel structure of a display panel of FIG. 1;

FIG. 3 is a block diagram illustrating a timing controller of FIG. 1;

FIGS. 4A and 4B are conceptual diagrams illustrating a vertical line defect on the display panel of FIG. 1;

FIG. 5 is a flow chart illustrating an operation of an inversion controlling part of FIG. 3;

FIG. 6A is a conceptual diagram illustrating pixel voltages applied to subpixels of the display panel of FIG. 1 in a column inversion method;

FIG. 6B is a conceptual diagram illustrating pixel voltages applied to subpixels of the display panel of FIG. 1 in a dot inversion method;

FIG. 7 is a plan view illustrating a pixel structure of a display panel according to an exemplary embodiment of the present inventive concept;

FIGS. 8A and 8B are conceptual diagrams illustrating a vertical line defect on the display panel of FIG. 7;

FIG. 9 is a block diagram illustrating a timing controller according to an exemplary embodiment of the present inventive concept;

FIG. 10 is a block diagram illustrating an inversion controlling part of FIG. 9;

FIG. 11 is a flow chart illustrating an operation of a scramble signal generating part of FIG. 10;

FIG. 12 is a circuit diagram illustrating an inverting signal generating part of FIG. 10; and

FIG. 13 is a timing diagram illustrating an output signal of the inverting signal generating part of FIG. 10.

### DETAILED DESCRIPTION OF THE INVENTIVE CONCEPT

Hereinafter, the present inventive concept will be explained in detail with reference to the accompanying drawings.

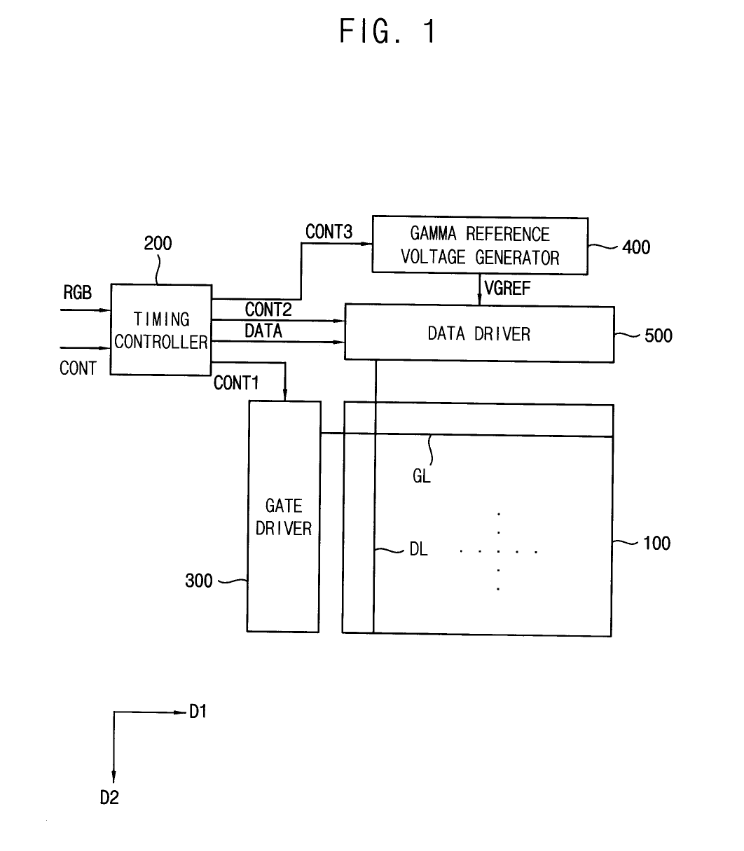

FIG. 1 is a block diagram illustrating a display apparatus according to an exemplary embodiment of the present invention.

Referring to FIG. 1, the display apparatus includes a display panel 100 and a panel driver. The panel driver includes a timing controller 200, a gate driver 300, a gamma reference voltage generator 400 and a data driver 500.

The display panel 100 has a display region on which an image is displayed and a peripheral region adjacent to the display region.

The display panel 100 includes a plurality of gate lines GL, a plurality of data lines DL and a plurality of subpixels connected to the gate lines GL and the data lines DL. The gate lines GL extend in a first direction D1 and the data lines DL extend in a second direction D2 crossing the first direction D1.

Each subpixel includes a switching element (not shown), a liquid crystal capacitor (not shown) and a storage capacitor (not shown). The liquid crystal capacitor and the storage capacitor are electrically connected to the switching element. The subpixels may be disposed in a matrix form. Some of the subpixels may form a pixel. For example, a red subpixel, a green subpixel and a blue subpixel may form a pixel.

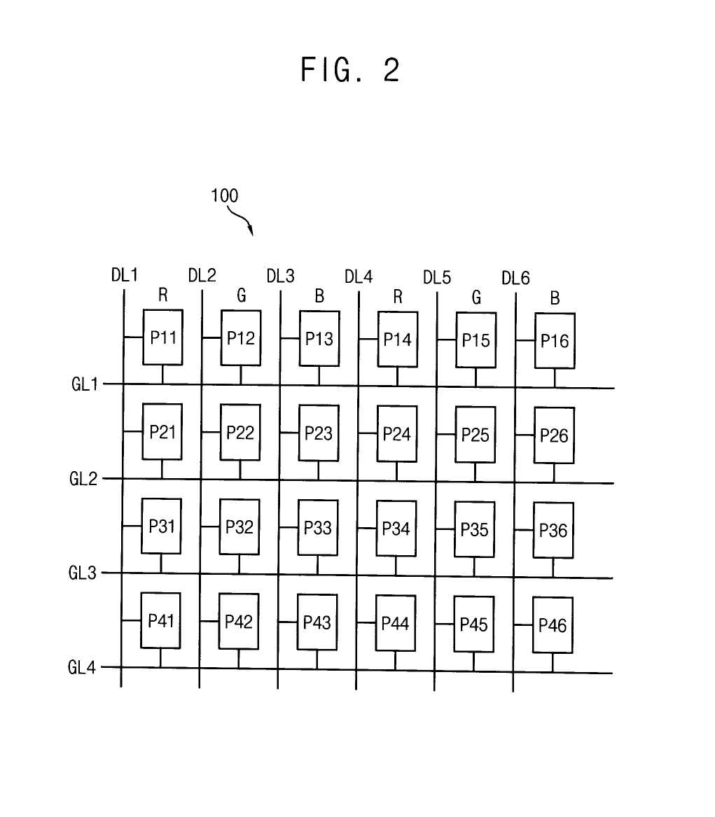

A pixel structure of the display panel 100 may be explained referring to FIG. 2 in detail.

The timing controller 200 receives input image data RGB and an input control signal CONT from an external apparatus (not shown). The input image data may include red image data R, green image data G and blue image data B. The input control signal CONT may include a master clock signal and a data enable signal. The input control signal CONT may include a vertical synchronizing signal and a horizontal synchronizing signal.

The timing controller 200 generates a first control signal CONT1, a second control signal CONT2, a third control signal CONT3 and a data signal DATA based on the input image data RGB and the input control signal CONT.

The timing controller 200 generates the first control signal CONT1 for controlling an operation of the gate driver 300 based on the input control signal CONT, and outputs the first control signal CONT1 to the gate driver 300. The first control signal CONT1 may further include a vertical start signal and a gate clock signal.

The timing controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal. The second control signal CONT2 may further include an inversion control signal.

The timing controller 200 generates the data signal DATA based on the input image data RGB. The timing controller 200 outputs the data signal DATA to the data driver 500.

The timing controller 200 generates the third control signal CONT3 for controlling an operation of the gamma reference voltage generator 400 based on the input control signal CONT, and outputs the third control signal CONT3 to the gamma reference voltage generator 400.

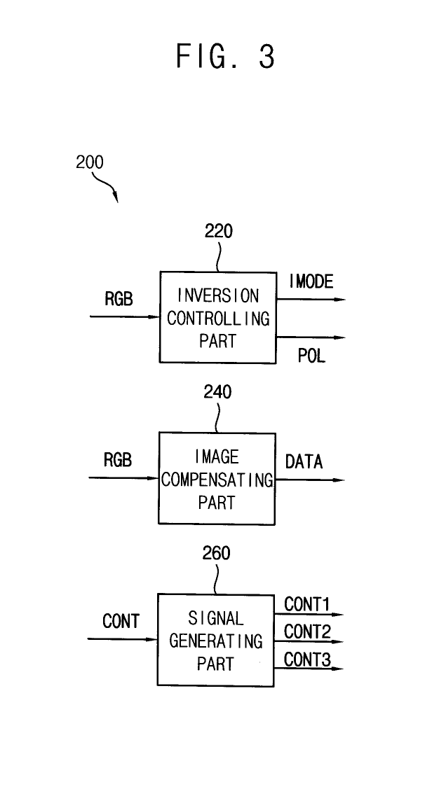

A structure of the timing controller driver 200 is explained referring to FIG. 3 in detail.

The gate driver 300 generates gate signals driving the gate lines GL in response to the first control signal CONT1 received from the timing controller 200. The gate driver 300 sequentially outputs the gate signals to the gate lines GL.

The gate driver 300 may be directly mounted on the display panel 100, or may be connected to the display panel 100 as a tape carrier package (TCP) type. Alternatively, the gate driver 300 may be integrated on the display panel 100.

The gamma reference voltage generator 400 generates a gamma reference voltage VGREF in response to the third control signal CONT3 received from the timing controller 200. The gamma reference voltage generator 400 provides the gamma reference voltage VGREF to the data driver 500. The gamma reference voltage VGREF has a value corresponding to a level of the data signal DATA.

In an exemplary embodiment, the gamma reference voltage generator 400 may be disposed in the timing controller 200, or in the data driver 500.

The data driver 500 receives the second control signal CONT2 and the data signal DATA from the timing controller 200, and receives the gamma reference voltages VGREF from the gamma reference voltage generator 400. The data driver 500 converts the data signal DATA into data voltages having an analog type using the gamma reference voltages VGREF. The data driver 500 sequentially outputs the data voltages to the data lines DL.

The data driver 500 may be directly mounted on the display panel 100, or be connected to the display panel 100 as a TCP type. Alternatively, the data driver 500 may be integrated on the peripheral region of the display panel 100.

FIG. 2 is a plan view illustrating a pixel structure of the display panel 100 of FIG. 1.

Referring to FIGS. 1 and 2, the display panel 100 includes a plurality of subpixels. The subpixels form a subpixel row in the first direction D1 and a subpixel column in the second direction D2.

The display panel 100 has a non-alternating pattern. In the non-alternating pattern, the subpixels in the subpixel column are connected to the same data line.

A single gate line GL is connected to subpixels in a single subpixel row. A single data line DL is connected to subpixel in a single subpixel column.

For example, the first gate line GL1 is connected to subpixels P11, P12, P13, P14, P15 and P16 in a first subpixel row. The second gate line GL2 is connected to subpixels P21, P22, P23, P24, P25 and P26 in a second subpixel row.

For example, the first data line DL1 is connected to subpixels P11, P21, P31 and P41 in a first subpixel column. The second data line DL2 is connected to subpixels P12, P22, P32 and P42 in a second subpixel column.

The display panel 100 includes subpixel columns and each subpixel column includes subpixels representing the same color. The display panel 100 includes subpixel rows and each subpixel row sequentially includes a red subpixel R, a green subpixel G and a blue subpixel B.

For example, the first subpixel column connected to the first data line DL1 includes red subpixels R. The second subpixel column connected to the second data line DL2 includes green subpixels G. The third subpixel column connected to the third data line DL3 includes blue subpixels B.

For example, the first subpixel row connected to the first gate line GL1 sequentially includes red, green and blue subpixels R, G and B.

Although subpixels in four rows and six columns are shown in FIG. 2, the display panel 100 may include further subpixels which are not shown in FIG. 2.

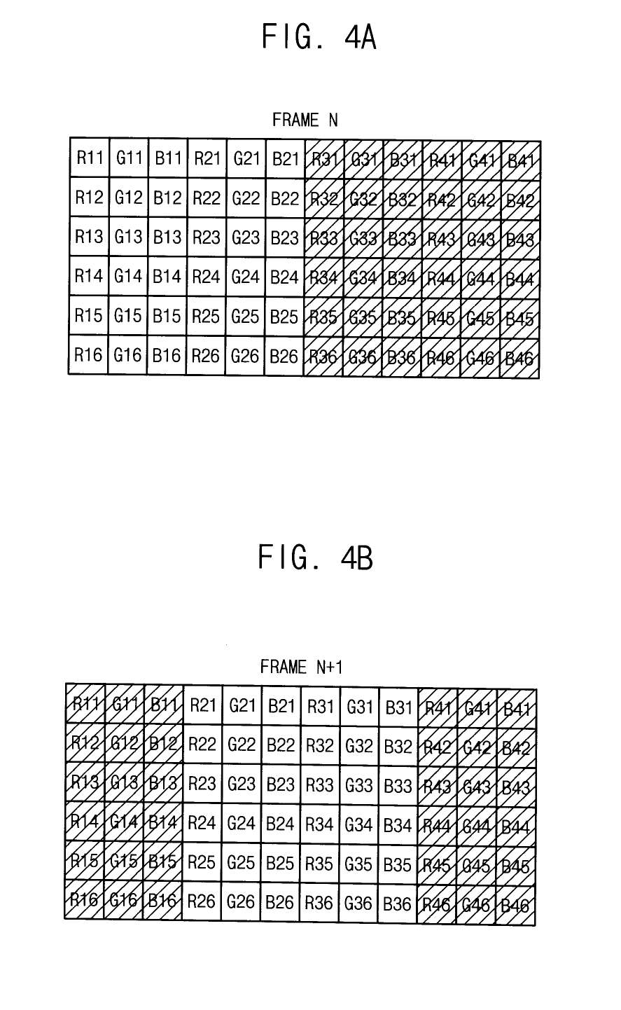

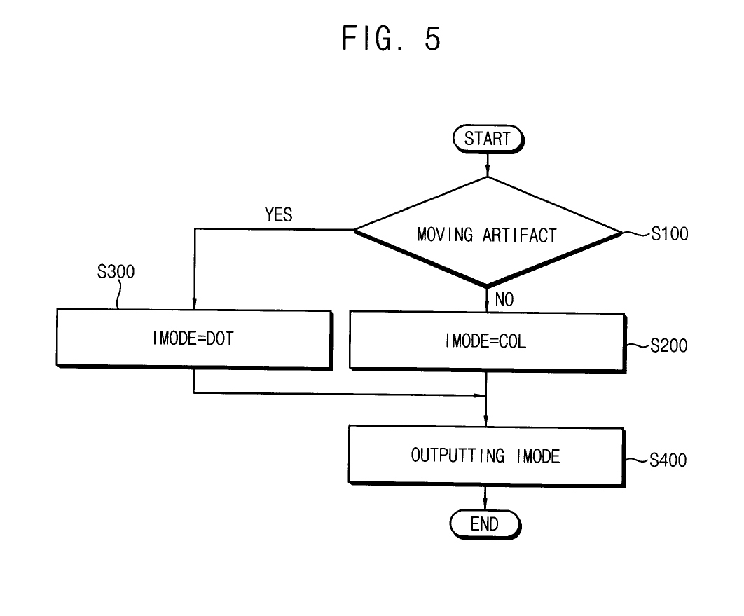

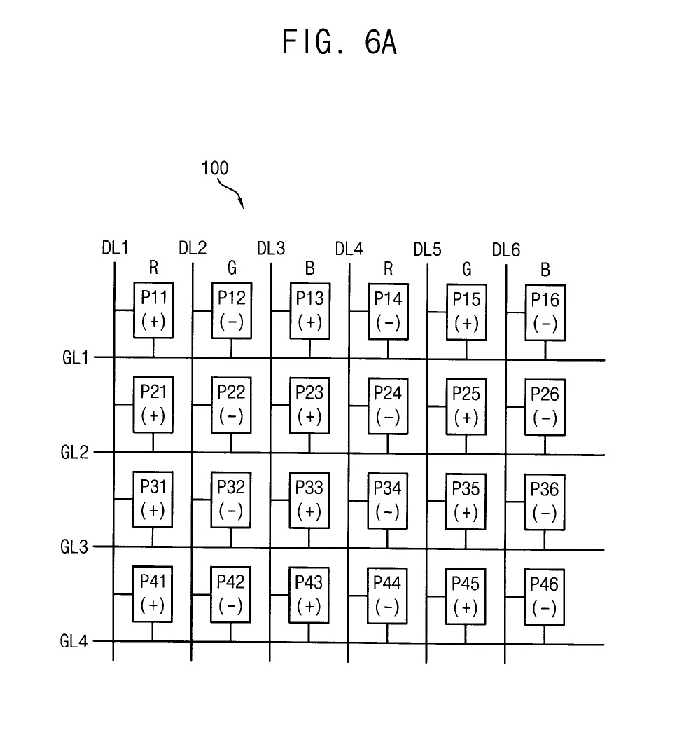

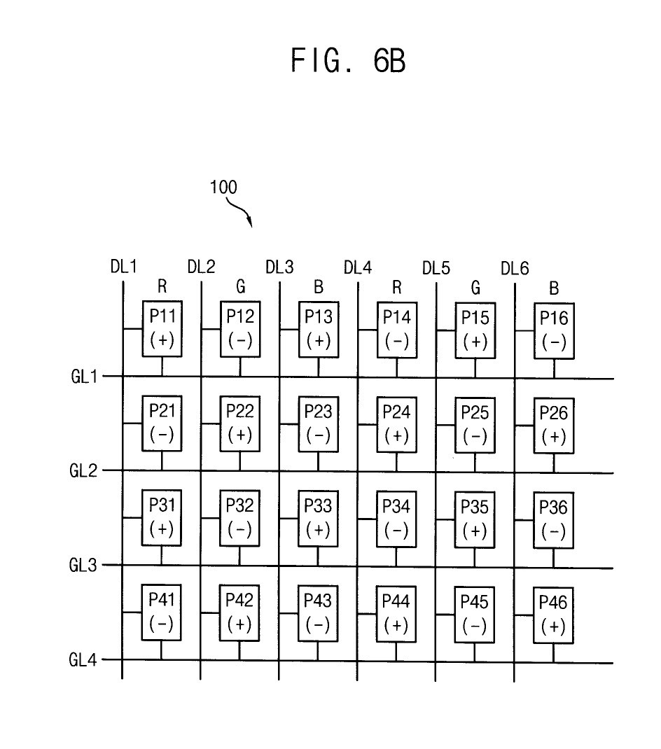

FIG. 3 is a block diagram illustrating the timing controller 200 of FIG. 1. FIGS. 4A and 4B are conceptual diagrams illustrating a vertical line defect on the display panel 100 of FIG. 1. FIG. 5 is a flow chart illustrating an operation of an inversion controlling part 220 of FIG. 3. FIG. 6A is a conceptual diagram illustrating pixel voltages applied to subpixels of the display panel 100 of FIG. 1 in a column inversion method. FIG. 6B is a conceptual diagram illustrating pixel voltages applied to subpixels of the display panel 100 of FIG. 1 in a dot inversion method.

Referring to FIGS. 1 to 6B, the timing controller 200 includes an inversion controlling part 220, an image compensating part 240 and a signal generating part 260.

The inversion controlling part 220 receives the input image data RGB. The inversion controlling part 220 outputs an inversion control signal. The inversion control signal includes an inversion mode signal IMODE and a normal inverting signal POL. The inversion mode signal IMODE may selectively represent one of a column inversion method and one dot inversion method. The inversion mode signal IMODE may further represent a frame inversion method and a two by one dot inversion method.

In the column inversion method, during a first frame, pixel voltages having a first polarity are applied to odd numbered data lines DL1, DL3 and DL5, and pixel voltages having a second polarity opposite to the first polarity are applied to even numbered data lines DL2, DL4 and DL6. For example, pixel voltages having a first polarity are applied to a first data line DL1 and pixel voltages having a second polarity opposite to the first polarity are applied to a second data line DL2 adjacent to the first data line DL1. During a second frame, pixel voltages having the second polarity are applied to the odd numbered data lines DL1, DL3 and D5, and pixel voltages having the first polarity are applied to the even numbered data lines DL2, DL4 and D16. For example, pixel voltages having the second polarity are applied to the first data line DL1 and pixel voltages having the first polarity are applied to the second data line DL2. The above explained inversion sequence is repeated.

In the one dot inversion method, during a first frame, a positive pixel voltage, a negative pixel voltage, a positive pixel voltage and a negative pixel voltage are sequentially applied to the odd numbered data lines DL1, DL3 and DL5, and a negative pixel voltage, a positive pixel voltage, a negative pixel voltage and a positive pixel voltage are sequentially applied to the even numbered data lines DL2, DL4 and DL6. During a second frame, a negative pixel voltage, a positive pixel voltage, a negative pixel voltage and a positive pixel voltage are sequentially applied to the odd numbered data lines DL1, DL3 and DL5, and a positive pixel voltage, a negative pixel voltage, a positive pixel voltage and a negative pixel voltage are sequentially applied to the even numbered data lines DL2, DL4 and D16. The above explained inversion sequence is repeated.

In the frame inversion method, during a first frame, pixel voltages having a first polarity are applied to all of the subpixels in the display panel 100. During a second frame, pixel voltages having a second polarity are applied to all of the subpixels in the display panel 100. The above explained inversion sequence is repeated.

In the two by one dot inversion method, during a first frame, a positive pixel voltage, a negative pixel voltage, a negative pixel voltage, a positive pixel voltage, a positive pixel voltage and a negative pixel voltage are sequentially applied to the odd numbered data lines DL1, DL3 and DL5, and a negative pixel voltage, a positive pixel voltage, a positive pixel voltage, a negative pixel voltage, a negative pixel voltage and a positive pixel voltage are sequentially applied to the even numbered data lines DL2, DL4 and DL6. During a second frame, a negative pixel voltage, a positive pixel voltage, a positive pixel voltage, a negative pixel voltage, a negative pixel voltage and a positive pixel voltage are sequentially applied to the odd numbered data lines DL1, DL3 and DL5, and a positive pixel voltage, a negative pixel voltage, a negative pixel voltage, a positive pixel voltage, a positive pixel voltage and a negative pixel voltage are sequentially applied to the even numbered data lines DL2, DL4 and DL6. The above explained inversion sequence is repeated.

The inversion controlling part 220 compares a previous frame data and a present frame data to determine that the input image data RGB includes a pattern prone to generate a moving artifact (hereinafter referred to as “a moving artifact pattern”) (step S100).

When the previous frame data and the present frame data represent the moving artifact pattern, the inversion mode signal IMODE may include the dot inversion method DOT (step S300). When the previous frame data and the present frame data do not represent the moving artifact pattern, the inversion mode signal IMODE may include the column inversion method COL (step S200). Alternatively, when the previous frame data and the present frame data represent the moving artifact pattern, the inversion mode signal IMODE includes the two by one dot inversion method. Alternatively, when the previous frame data and the present frame data represent the moving artifact pattern, the inversion mode signal IMODE includes one of two by two dot inversion method, three by one dot inversion method, three by two dot inversion method and so on.

FIGS. 4A and 4B represent an image which may generate the moving artifact. The red subpixel, the green subpixel and the blue subpixel form a pixel so that first to third subpixel columns form a first pixel column, fourth to sixth subpixel columns form a second pixel column, seventh to ninth subpixel columns form a third pixel column and tenth to twelfth subpixel columns form a fourth pixel column.

In an N-th frame, for example, subpixels in the first to sixth subpixel columns represent a grayscale of white and other subpixels represent a grayscale of black so that first and second pixel columns represent the grayscale of white and other pixel columns represent the grayscale of black.

In an (N+1)-th frame, for example, subpixels in the fourth to ninth subpixel columns represent the grayscale of white and other subpixels represent the grayscale of black so that second and third pixel columns represent the grayscale of white and other pixel columns represent the grayscale of black.

In the N-th frame and the (N+1)-th frame, the white pattern is shifted by one pixel (three subpixels) in a row direction.

When the display panel 100 is driven in the column inversion method, in the N-th frame FRAME N, the first pixel column may include a positive red pixel voltage, a negative green pixel voltage and a positive blue pixel voltage and the second pixel column may include a negative red pixel voltage, a positive green pixel voltage and a negative blue pixel voltage.

In the (N+1)-th frame FRAME N+1, polarities of the subpixels are inverted with respect to the N-th frame. Thus, in the (N+1)-th frame FRAME N+1, the second pixel column may include a positive red pixel voltage, a negative green pixel voltage and a positive blue pixel voltage and the third pixel column may include a negative red pixel voltage, a positive green pixel voltage and a negative blue pixel voltage.

A viewer's viewpoint tends to follow a moving object. Thus, the viewer's viewpoint follows the white pattern on the display panel 100 so that a polarity of the first pixel column which corresponds to a left boundary of the white pattern in the N-th frame FRAME N may be same as a polarity of the second pixel column which corresponds to a left boundary of the white pattern in the (N+1)-th frame FRAME N+1. In addition, a polarity of the second pixel column which corresponds to a right boundary of the white pattern in the N-th frame FRAME N may be same as a polarity of the third pixel column which corresponds to a right boundary of the white pattern in the (N+1)-th frame FRAME N+1.

Accordingly, even when the polarity of the subpixel is inverted in every frame, the polarity of the object is not changed in the viewer's viewpoint. Therefore, the vertical line defect due to a difference of luminance between the positive subpixel column and the negative subpixel column may be generated.

Although the white pattern is shifted by one pixel (three subpixels) in FIGS. 4A and 4B, the present invention is not limited thereto. When the white pattern is shifted by odd number of pixels (three by odd number subpixels) between adjacent frames, the moving artifact may be generated.

The inversion controlling part 220 may compare grayscale voltages of one data line in the previous frame data and grayscale voltages of one data line in the present frame data to determine the inversion mode signal IMODE. For example, the inversion controlling part 220 may determine the inversion mode signal IMODE by comparing grayscale voltages of M-th data line in the previous frame data and grayscale voltages of (M+3)-th data line in the present frame data, M being an positive integer. For example, the inversion controlling part 220 may determine the inversion mode signal IMODE by comparing grayscale voltages of first subpixel column R11, R12, R13, R14, R15 and R16 in FIG. 4A and grayscale voltages of fourth subpixel column R21, R22, R23, R24, R25 and R26 in FIG. 4B.

Alternatively, the inversion controlling part 220 may compare all grayscale voltages of the previous frame data and all grayscale voltages of the present frame data to determine the inversion mode signal IMODE.

Alternatively, the inversion controlling part 220 may compare sampled grayscale voltages of the previous frame data and sampled grayscale voltages of the present frame data to determine the inversion mode signal IMODE.

The inversion controlling part 220 outputs the inversion mode signal IMODE to the data driver 500 (step S400).

FIG. 6A represents pixel voltages applied to the subpixels in the display panel 100 when the inversion mode signal IMODE includes the column inversion method COL.

In the column inversion method COL, positive pixel voltages are applied to the first, third and fifth subpixel columns and negative pixel voltages are applied to the second, fourth and sixth subpixel columns.

Although not shown in figures, negative pixel voltages may be applied to the first, third and fifth subpixel columns and positive pixel voltages may be applied to the second, fourth and sixth subpixel columns in a frame next to a frame of FIG. 6A.

FIG. 6B represents pixel voltages applied to the subpixels in the display panel 100 when the inversion mode signal IMODE includes the dot inversion method DOT.

In the dot inversion method DOT, a positive pixel voltage, a negative pixel voltage, a positive pixel voltage and a negative pixel voltage are applied to the first, third and fifth subpixel columns and a negative pixel voltage, a positive pixel voltage, a negative pixel voltage and a positive pixel voltage are applied to the second, fourth and sixth subpixel columns.

Although not shown in figures, a negative pixel voltage, a positive pixel voltage, a negative pixel voltage and a positive pixel voltage may be applied to the first, third and fifth subpixel columns and a positive pixel voltage, a negative pixel voltage, a positive pixel voltage and a negative pixel voltage may be applied to the second, fourth and sixth subpixel columns in a frame next to a frame of FIG. 6A.

The inversion controlling part 220 may further output the normal inverting signal POL to the data driver 500. The normal inverting signal POL may have one of a high level and a low level. The normal inverting signal POL may alternately and repeatedly have a high level and a low level by every frame.

In the column inversion method COL, when the normal inverting signal POL has a high level, positive pixel voltages may be applied to the even numbered data lines DL1, DL3 and DL5 of the display panel 100 and negative pixel voltages may be applied to the even numbered data lines DL2, DL4 and DL6 of the display panel 100. When the normal inverting signal POL has a low level, negative pixel voltages may be applied to the odd numbered data lines DL1, DL3 and DL5 of the display panel 100 and positive pixel voltages may be applied to the even numbered data lines DL2, DL4 and DL6 of the display panel 100.

In the dot inversion method DOT, when the normal inverting signal POL has a high level, a positive pixel voltage, a negative pixel voltage, a positive pixel voltage and a negative pixel voltage may be sequentially applied to the odd numbered data lines DL1, DL3 and DL5 of the display panel 100 and a negative pixel voltage, a positive pixel voltage, a negative pixel voltage and a positive pixel voltage may be sequentially applied to the even numbered data line DL2, DL4 and D16 of the display panel 100. When the normal inverting signal POL has a low level, a negative pixel voltage, a positive pixel voltage, a negative pixel voltage and a positive pixel voltage may be sequentially applied to the odd numbered data lines DL1, D13 and DL5 of the display panel 100 and a positive pixel voltage, a negative pixel voltage, a positive pixel voltage and a negative pixel voltage may be sequentially applied to the even numbered data lines DL2, DL4 and DL6 may be applied to the second data line DL2 of the display panel 100.

When the input image data RGB has a frame rate of about 60 Hz and an output image data has a frame rate of about 60 Hz, the inversion controlling part 220 may compare the grayscale voltage of the present frame data and the grayscale voltage of the previous frame data based on a frame of the input image data RGB.

When the input image data RGB has a frame rate of about 60 Hz and an output image data has a frame rate of about 120 Hz, the timing controller 200 may copy the input image data RGB to generate a medium frame image data having the frame rate of about 120 Hz. The inversion controlling part 220 may compare the grayscale voltage of the present frame data and the grayscale voltage of the previous frame data based on a frame of the input image data RGB. Alternatively, the inversion controlling part 220 may compare the grayscale voltage of the present frame data and a grayscale voltage of a frame data before the previous frame data based on a frame of the medium frame image data.

In the present exemplary embodiment, the inversion controlling part 220 is included in the timing controller 200. However, the present inventive concept is not limited thereto. Alternatively, the inversion controlling part 220 may be formed independently from the timing controller 200. Alternatively, the inversion controlling part 220 may be included in the data driver 500.

The image compensating part 240 compensates the input image data RGB to generate a data signal DATA.

The image compensating part 240 may include an adaptive color correcting part (not shown) and a dynamic capacitance compensating part (not shown).

The adaptive color correcting part receives the input image data RGB and carries out an adaptive color correction (“ACC”). The adaptive color correcting part may compensate the input image data RGB using a gamma curve.

The dynamic capacitance compensating part carries out a dynamic capacitance compensation (“DCC”), which compensates the grayscale data of present frame data using previous frame data and the present frame data.

The signal generating part 260 generates the first control signal CONT1 based on the input control signal CONT. The signal generating part 260 outputs the first control signal CONT1 to the gate driver 300. The signal generating part 260 generates the second control signal CONT2 based on the input control signal CONT. The signal generating part 260 outputs the second control signal CONT2 to the data driver 300. The signal generating part 260 generates the third control signal CONT3 based on the input control signal CONT. The signal generating part 260 outputs the third control signal CONT3 to the gamma reference voltage generator 400.

According to the present exemplary embodiment, when a comparison result shows that a pattern prone to generate the moving artifact exists, the present frame data is driven in the dot inversion driving method so that the display quality may be improved.

In contrast, when the comparison result shows that a pattern prone to generate the moving artifact does not exist, the present frame data is driven in the column inversion driving method so that the power consumption may be decreased.

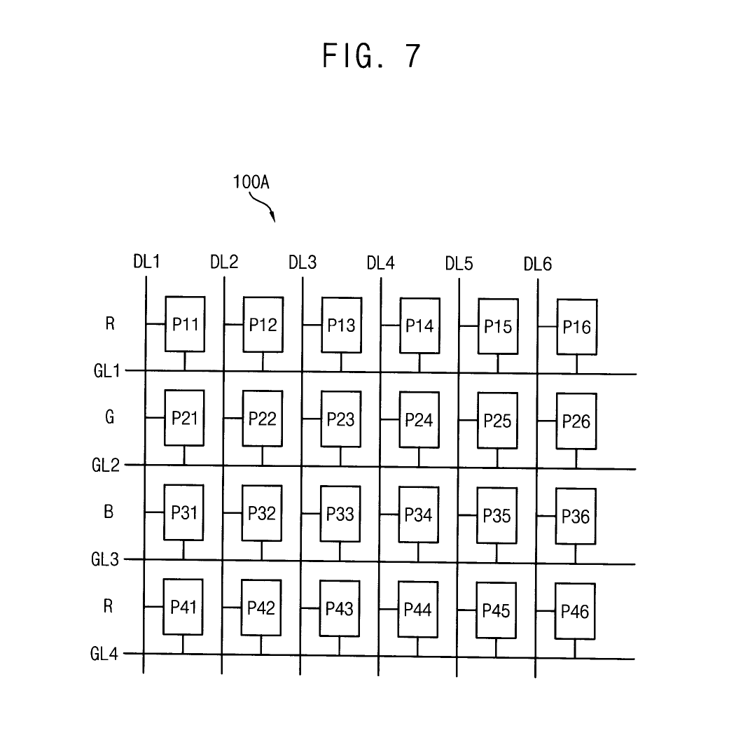

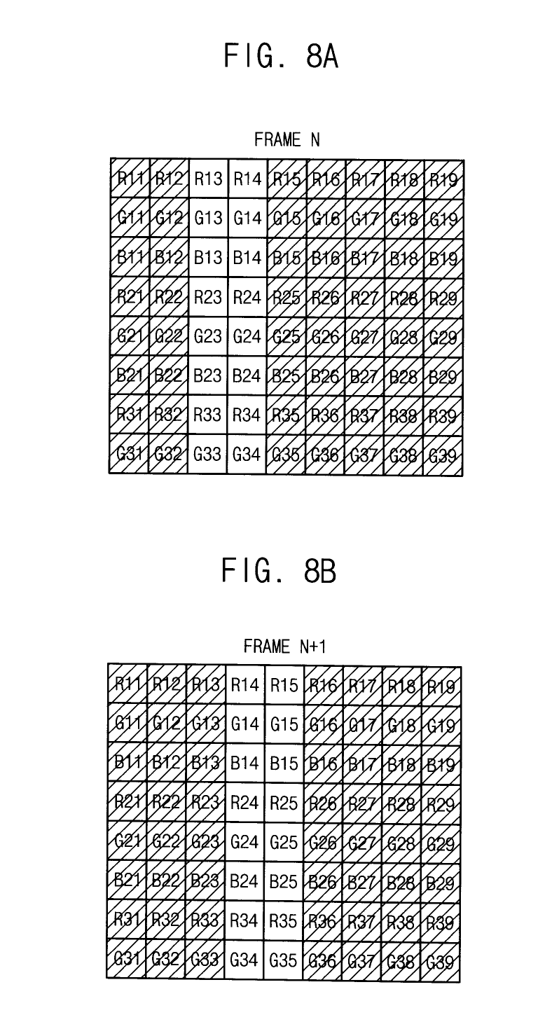

FIG. 7 is a plan view illustrating a pixel structure of a display panel 100A according to an exemplary embodiment of the present inventive concept. FIGS. 8A and 8B are conceptual diagrams illustrating a vertical line defect on the display panel 100A of FIG. 7.

The display apparatus according to the present exemplary embodiment is substantially the same as the display apparatus of the previous exemplary embodiment explained referring to FIGS. 1 to 6B except for a pixel structure of the display panel. Thus, the same reference numerals will be used to refer to the same or like parts as those described in the previous exemplary embodiment of FIGS. 1 to 6B and any repetitive explanation concerning the above elements will be omitted.

Referring to FIGS. 1, 3, 5, 6A, 6B, 7, 8A and 8B, the display apparatus includes a display panel 100A and a panel driver. The panel driver includes a timing controller 200, a gate driver 300, a gamma reference voltage generator 400 and a data driver 500.

The display panel 100A has a display region on which an image is displayed and a peripheral region adjacent to the display region.

The display panel 100A includes a plurality of gate lines GL, a plurality of data lines DL and a plurality of subpixels connected to the gate lines GL and the data lines DL. The gate lines GL extend in a first direction D1 and the data lines DL extend in a second direction D2 crossing the first direction D1.

The display panel 100A includes a plurality of subpixels. The subpixels form a subpixel row in the first direction D1 and a subpixel column in the second direction D2.

The display panel 100A has a non-alternating pattern. In the non-alternating pattern, the subpixels in the subpixel column are connected to the same data line.

A single gate line GL is connected to subpixels in a single subpixel row. A single data line DL is connected to subpixel in a single subpixel column.

For example, the first gate line GL1 is connected to subpixels P11, P12, P13, P14, P15 and P16 in a first subpixel row. The second gate line GL2 is connected to subpixels P21, P22, P23, P24, P25 and P26 in a second subpixel row.

For example, the first data line DL1 is connected to subpixels P11, P21, P31 and P41 in a first subpixel column. The second data line DL2 is connected to subpixels P12, P22, P32 and P42 in a second subpixel column.

The display panel 100A includes subpixel columns and each subpixel column sequentially includes a red subpixel R, a green subpixel G and a blue subpixel B. The display panel 100A includes subpixel rows and each subpixel row includes subpixels representing the same color.

For example, the first subpixel column connected to the first data line DL1 sequentially includes red, green and blue subpixels R, G and B.

For example, the first subpixel row connected to the first gate line GL1 includes red subpixels R. The second subpixel row connected to the second gate line GL2 includes green subpixels G. The third subpixel row connected to the third gate line GL3 includes blue subpixels B.

Although subpixels in four rows and six columns are shown in FIG. 7, the display panel 100A may include further subpixels which are not shown in FIG. 7.

The timing controller 200 includes an inversion controlling part 220, an image compensating part 240 and a signal generating part 260.

The inversion controlling part 220 receives the input image data RGB. The inversion controlling part 220 outputs an inversion control signal. The inversion control signal includes an inversion mode signal IMODE and a normal inverting signal POL. The inversion mode signal IMODE may selectively include one of a column inversion method and a dot column inversion method. The inversion mode signal IMODE may further include a frame inversion method and a two by one dot inversion method.

The inversion controlling part 220 compares a previous frame data and a present frame data to determine that the input image data RGB generates a moving artifact pattern (step S100).

When the previous frame data and the present frame data represent the moving artifact pattern, the inversion mode signal IMODE may include the dot inversion method DOT (step S300). When the previous frame data and the present frame data do not represent the moving artifact pattern, the inversion mode signal IMODE may include the column inversion method COL (step S200).

FIGS. 8A and 8B represent an image which may generate the moving artifact. The red subpixel, the green subpixel and the blue subpixel form a pixel so that first to third subpixel rows form a first pixel row, fourth to sixth subpixel rows form a second pixel row, seventh to ninth subpixel rows form a third pixel row and tenth to twelfth subpixel rows form a fourth pixel row.

In contrast, the subpixel column is the same as the pixel column. The first subpixel column forms a first pixel column. The second subpixel column forms a second pixel column. The third subpixel column forms a third pixel column. The fourth subpixel column forms a fourth pixel column.

In an N-th frame, subpixels in the third and fourth subpixel columns represent a grayscale of white and other subpixels represent a grayscale of black.

In an (N+1)-th frame, subpixels in the fourth and fifth subpixel columns represent the grayscale of white and other subpixels represent the grayscale of black.

In the N-th frame and the (N+1)-th frame, the white pattern is shifted by one pixel (one subpixel) in a row direction.

When the display panel 100A is driven in the column inversion method, in the N-th frame FRAME N, the third pixel column may include a positive pixel voltage and the fourth pixel column may include a negative pixel voltage.

In the (N+1)-th frame FRAME N+1, polarities of the subpixels are inverted with respect to the N-th frame. Thus, in the (N+1)-th frame FRAME N+1, the fourth pixel fourth column may include a positive pixel voltage and the fifth pixel column may include a negative pixel voltage.

A viewer's viewpoint tends to follow a moving object. Thus, the viewer's viewpoint follows the white pattern on the display panel 100A so that a polarity of the third pixel column which corresponds to a left boundary of the white pattern in the N-th frame FRAME N may be same as a polarity of the fourth pixel column which corresponds to a left boundary of the white pattern in the (N+1)-th frame FRAME N+1. In addition, a polarity of the fourth pixel column which corresponds to a right boundary of the white pattern in the N-th frame FRAME N may be same as a polarity of the fifth pixel column which corresponds to a right boundary of the white pattern in the (N+1)-th frame FRAME N+1.

Accordingly, even when the polarity of the subpixel is inverted in every frame, the polarity of the object is not changed in the viewer's viewpoint. Therefore, the vertical line defect due to a difference of luminance between the positive subpixel column and the negative subpixel column may be generated.

Although the white pattern is shifted by one pixel (one subpixel) in FIGS. 8A and 8B, the present invention is not limited thereto. When the white pattern is shifted by odd number of pixels (odd subpixels) between adjacent frames, the moving artifact may be generated.

The inversion controlling part 220 may compare grayscale voltages of one data line in the previous frame data and grayscale voltages of one data line in the present frame data to determine the inversion mode signal IMODE. For example, the inversion controlling part 220 may determine the inversion mode signal IMODE by comparing grayscale voltages of M-th data line in the previous frame data and grayscale voltages of (M+1)-th data line in the present frame data, M being a positive integer. For example, the inversion controlling part 220 may determine the inversion mode signal IMODE by comparing grayscale voltages of third subpixel column R13, G13, B13, R23, G23, B23, R33 and G33 in FIG. 8A and grayscale voltages of fourth subpixel column R14, G14, B14, R24, G24, B24, R34 and G34 in FIG. 8B.

The inversion controlling part 220 outputs the inversion mode signal IMODE to the data driver 500 (step S400).

According to the present exemplary embodiment, when the moving artifact is determined by comparing the previous frame data and the present frame data, the present frame data is driven in the dot inversion driving method so that the display quality may be improved.

In contrast, when the moving artifact is not determined by comparing the previous frame data and the present frame data, the present frame data is driven in the column inversion driving method so that the power consumption may be decreased.

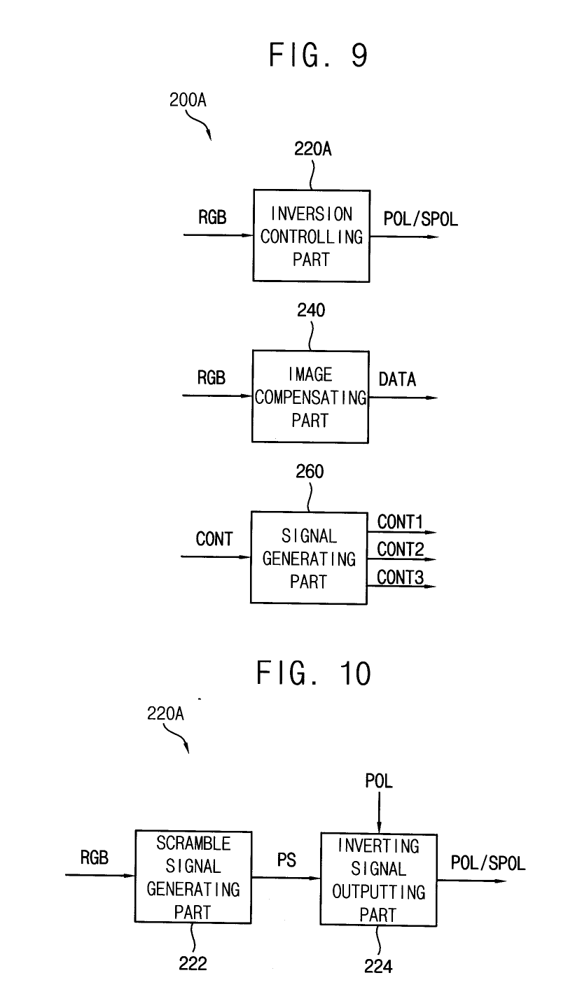

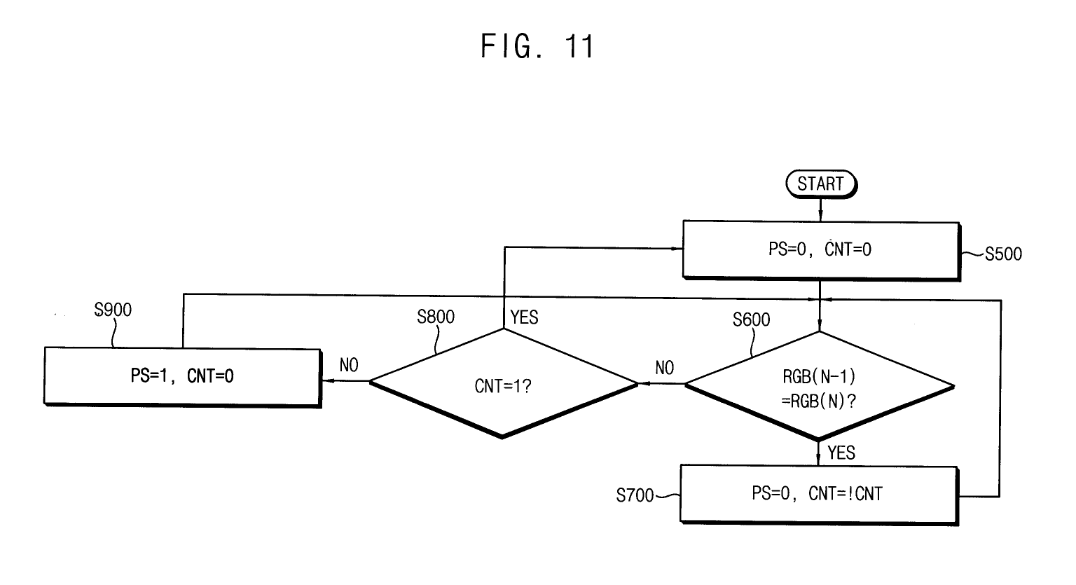

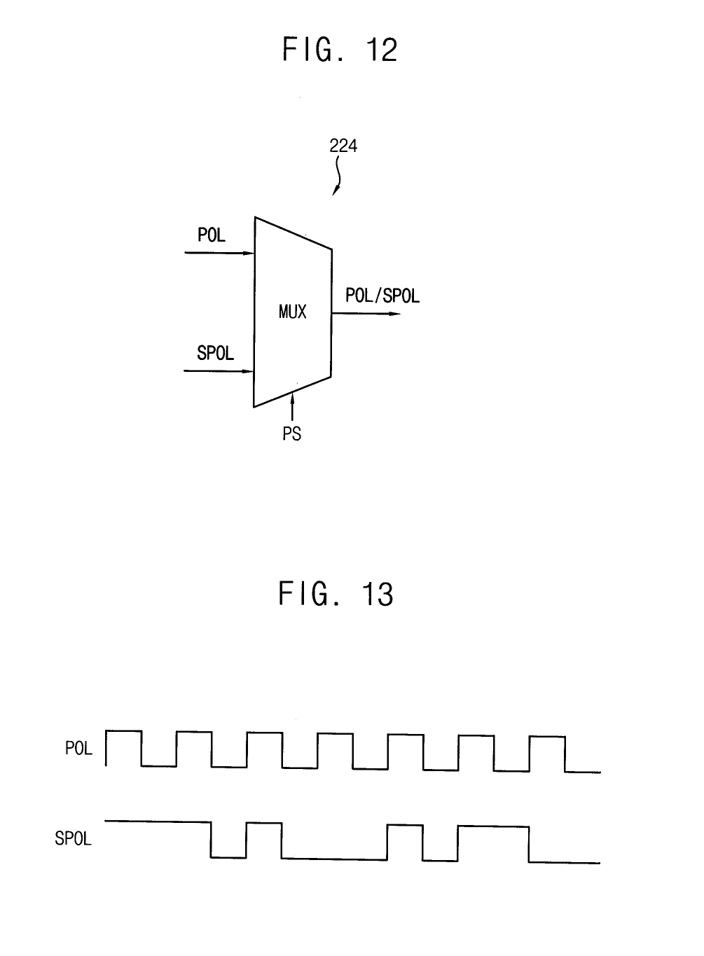

FIG. 9 is a block diagram illustrating a timing controller 200A according to an exemplary embodiment of the present inventive concept. FIG. 10 is a block diagram illustrating the inversion controlling part 220A of FIG. 9. FIG. 11 is a flow chart illustrating an operation of a scramble signal generating part 222 of FIG. 10. FIG. 12 is a circuit diagram illustrating an inverting signal generating part 224 of FIG. 10. FIG. 13 is a timing diagram illustrating an output signal of the inverting signal generating part 224 of FIG. 10.

The display apparatus according to the present exemplary embodiment is substantially the same as the display apparatus of the previous exemplary embodiment explained referring to FIGS. 1 to 6B except for an inversion controlling part. Thus, the same reference numerals will be used to refer to the same or like parts as those described in the previous exemplary embodiment of FIGS. 1 to 6B and any repetitive explanation concerning the above elements will be omitted.

Referring to FIGS. 1, 2, 9 to 13, the display apparatus includes a display panel 100 and a panel driver. The panel driver includes a timing controller 200, a gate driver 300, a gamma reference voltage generator 400 and a data driver 500.

The timing controller 200A receives input image data RGB and an input control signal CONT from an external apparatus (not shown). The input image data RGB may include red image data R, green image data G and blue image data B. The input control signal CONT may include a master clock signal and a data enable signal. The input control signal CONT may include a vertical synchronizing signal and a horizontal synchronizing signal.

The timing controller 200A generates a first control signal CONT1, a second control signal CONT2, a third control signal CONT3 and a data signal DATA based on the input image data RGB and the input control signal CONT.

The timing controller 200A generates the first control signal CONT1 for controlling an operation of the gate driver 300 based on the input control signal CONT, and outputs the first control signal CONT1 to the gate driver 300. The first control signal CONT1 may further include a vertical start signal and a gate clock signal.

The timing controller 200A generates the second control signal CONT2 for controlling an operation of the data driver 500 based on the input control signal CONT, and outputs the second control signal CONT2 to the data driver 500. The second control signal CONT2 may include a horizontal start signal and a load signal. The second control signal CONT2 may further include an inversion control signal.

The timing controller 200A generates the data signal DATA based on the input image data RGB. The timing controller 200A outputs the data signal DATA to the data driver 500.

The timing controller 200A generates the third control signal CONT3 for controlling an operation of the gamma reference voltage generator 400 based on the input control signal CONT, and outputs the third control signal CONT3 to the gamma reference voltage generator 400.

The timing controller 200A includes an inversion controlling part 220A, an image compensating part 240 and a signal generating part 260.

The inversion controlling part 220A receives the input image data RGB. The inversion controlling part 220 outputs an inversion control signal. The inversion control signal includes a normal inverting signal POL in a first operating mode and a scramble inverting signal SPOL in a second operating mode. The first operating mode represents a case which the moving artifact is not generated on the display panel 100. The second operating mode represents a case which the moving artifact is generated on the display panel 100.

The normal inverting signal POL has sequentially distributed high levels and low levels. The scramble inverting signal SPOL has a randomly distributed high levels and low levels.

In the normal inverting signal POL, the high level and the low level is sequentially repeated so that the normal inverting signal POL has a waveform substantially the same as a clock signal. In the normal inverting signal POL, the number of the high level pulses and the number of the low level pulses may be substantially the same.

When the display panel 100 is driven in the column inversion method and the inversion controlling part 220A outputs the normal inverting signal POL, in an N-th frame, positive pixel voltages are applied to an odd numbered data lines DL1, DL3 and DL5 of the display panel 100 and negative pixel voltages are applied to an even numbered data lines DL2, DL4 and DL6 of the display panel 100. In an (N+1)-th frame, negative pixel voltages are applied to the odd numbered data lines DL1, DL3 and DL5, and positive pixel voltages are applied to the even numbered data lines DL2, DL4 and DL6 of the display panel 100.

When the display panel 100 is driven by the normal inverting signal POL and the pattern of the input image data is shifted in a row direction in a specific velocity, the vertical line defect may be generated as explained referring to FIGS. 4A and 4B and 8A and 8B.

In the scramble inverting signal SPOL, the high level and the low level are randomly determined. The level of the scramble inverting signal SPOL, the high level or the low level, is determined randomly by a random coefficient. In the scramble inverting signal SPOL, the number of the high level and the number of the low level pulses may maintain to be substantially the same. In the scramble inverting signal SPOL, duration of the high level pulses and duration of the low level pulses may maintain to be substantially the same.

When the display panel 100 is driven in the column inversion method and the inversion controlling part 220A outputs the scramble inverting signal SPOL, positive pixel voltages and negative pixel voltages are randomly applied to a first data line DL1 of the display panel 100 but the number of applying the positive pixel voltages and the number of applying the negative pixel voltages may maintain to be substantially the same.

When the display panel 100 is driven by the scramble inverting signal SPOL, the vertical line defect may be prevented since the polarity of the pattern is randomly changed although the pattern of the input image data is shifted in a row direction in a specific velocity.

The inversion controlling part 220A includes a scramble signal generating part 222 and an inverting signal outputting part 224. The scramble signal generating part 222 compares the previous frame data and the present frame data to generate a scramble enable signal PS. The inverting signal outputting part 224 selectively outputs the normal inverting signal POL and the scramble inverting signal SPOL based on the scramble enable signal PS.

The scramble signal generating part 222 initializes the scramble enable signal PS and a counter signal to zero (step S500). For example, the scramble enable signal PS may be a binary signal having zero or one. For example, the counter signal CNT may be a binary signal having zero or one.

The scramble signal generating part 222 compares the previous frame data and the present frame data (step S600). In the present exemplary embodiment, the scramble signal generating part 222 may compare grayscale voltages of one data line in the previous frame data and grayscale voltages of one data line in the present frame data. Alternatively, the scramble signal generating part 222 may compare all grayscale voltages of the previous frame data and all grayscale voltages of the present frame data.

When the present frame data is substantially the same as the previous frame data, the scramble signal generating part 222 sets the scramble enable signal PS to zero and inverts the counter signal CNT (step S700). For example, when the counter signal CNT was zero, the counter signal CNT is set to one. When the counter signal CNT was one, the counter signal CNT is set to zero. The counter signal CNT represents an accumulated status of the polarity of the pixel. For example, when the counter signal CNT is zero, the polarity of the pixel is in a balanced status. When the counter signal CNT is one, the polarity of the pixel is in an unbalanced status. When the counter signal CNT is one, the polarity of the pixel is biased to the positive polarity or the negative polarity.

When the present frame data is different from the previous frame data, the scramble signal generating part 222 determines that the counter signal CNT is one (step S800). If the present frame data is different from the previous frame data, a pattern in the input image data RGB may be displaced which represents a moving image (video image).

When the input image data represents the video image and the polarity of the pixel is in the unbalanced status (CNT=1), the scramble signal generating part 222 sets the scramble enable signal PS to zero and the counter signal CNT to zero (step S500). When the input image data represents the video image, a possibility of the vertical line defect exists. However, when the polarity of the pixel is in the unbalanced status (CNT=1), the polarity of the pixel may be in the balanced status in a next frame due to the inversion of the pixel voltage so that the inverting signal is not required to be scrambled by the scramble inverting signal SPOL.

When the input image data represents the video image and the polarity of the pixel is in the balanced status (CNT=0), the scramble signal generating part 222 sets the scramble enable signal PS to 1 which represents scramble inverting signal and the counter signal CNT to zero (step S900). And then, the scramble signal generating part 222 compares the previous frame data and the present frame data again (step S600). When the input image data represents the video image, a possibility of the vertical line defect exists. Furthermore, when the polarity of the pixel is in the balanced status (CNT=0), the balance of the polarity of the pixel may be broken in a next frame due to the inversion of the pixel voltage so that the inverting signal is required to be scrambled by the scramble inverting signal SPOL. When the present frame data is different from the previous frame data and the counter signal CNT representing the accumulated status of the polarity is zero, the scramble signal generating part 222 sets the scramble enable signal PS to 1.

The inverting signal outputting part 224 selectively outputs one of the normal inverting signal POL and the scramble inverting signal SPOL based on the scramble enable signal PS.

For example, the scramble inverting signal SPOL may be generated by converting the normal inverting signal POL using the random coefficient.

The inverting signal outputting part 224 may include a multiplexer MUX. The multiplexer MUX may receive the scramble enable signal PS as a control signal and the normal inverting signal POL and the scramble inverting signal SPOL as input signals. The multiplexer MUX may output one of the normal inverting signal POL and the scramble inverting signal SPOL.

In the present exemplary embodiment, the display apparatus may employ the non-alternating display panel 100 of FIG. 2 and the non-alternating display panel 100A of FIG. 7. Alternatively, the display apparatus may employ an alternating display panel. The alternating display panel may include a data line alternately connected to subpixels in two subpixel columns. When the display apparatus of the present exemplary embodiment includes the alternating display panel, a moving dot defect may be prevented.

In the present exemplary embodiment, the inversion controlling part 220A is included in the timing controller 200A. However, the present inventive concept is not limited thereto. Alternatively, the inversion controlling part 220A may be formed independently from the timing controller 200A. Alternatively, the inversion controlling part 220A may be included in the data driver 500.

According to the present exemplary embodiment, when a comparison result shows that a pattern prone to generate the moving artifact exist, the display panel 100 is driven using the scramble inverting signal SPOL so that the display quality may be improved.

According to the present inventive concept as explained above, the previous frame data and the present frame data are compared to prevent the vertical line defect so that the display quality of the display panel may be improved. In addition, the power consumption of the display apparatus may be decreased.

The foregoing is illustrative of the present inventive concept and is not to be construed as limiting the scope of claims. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein.

What is claimed is:

1. A method of driving a display panel, the method comprising:
comparing a previous frame data and a present frame data;
outputting an inversion control signal of the present frame based on a result of the comparing the previous frame data and the present frame data:
generating a positive pixel voltage and a negative pixel voltage based on the inversion control signal; and
displaying an image based on the positive pixel voltage and the negative pixel voltage.

2. The method of claim 1,
wherein the inversion control signal comprises an inversion mode signal, the inversion mode signal including a column inversion mode signal and a dot inversion mode signal, the dot inversion mode signal including one dot inversion mode signal, two by one dot inversion mode signal, two by two dot inversion mode signal, three by one dot inversion mode signal and three by two dot inversion mode signal.

3. The method of claim 2, wherein, when the previous frame data and the present frame data represent a moving artifact pattern, the inversion mode signal includes the dot inversion mode signal, and, when the previous frame data and the present frame data do not represent the moving artifact pattern, the inversion mode signal includes the column inversion mode signal.

4. The method of claim 3, wherein the display panel comprises a non-alternating pattern in which all subpixels in a first subpixel column are connected to a data line, and
wherein, when a pattern between the previous frame data and the present frame data is shifted by odd number of pixels in a row direction, the pattern is determined as the moving artifact pattern.

5. The method of claim 4, wherein the comparing the previous frame data and the present frame data compares grayscale voltages of one data line in the previous frame data and grayscale voltages of one data line in the present frame data.

6. The method of claim 4, wherein the display panel comprises subpixel columns and subpixel rows, each of the subpixel columns comprises subpixels representing the same color, each of the subpixel rows sequentially comprises a red subpixel, a green subpixel and a blue subpixel, and wherein the comparing the previous frame data and the present frame data compares grayscale voltages of M-th data line in the previous frame data and grayscale voltages of (M+3)-th data line in the present frame data, M being an positive integer.

7. The method of claim 4, wherein the display panel comprises subpixel columns and subpixel rows, each of the subpixel columns sequentially comprises a red subpixel, a green subpixel and a blue subpixel, each of the subpixel rows comprises subpixels representing the same color, and
wherein the comparing the previous frame data and the present frame data compares grayscale voltages of M-th data line in the previous frame data and grayscale voltages of (M+1)-th data line in the present frame data, M being a positive integer.

8. The method of claim 1, wherein the inversion control signal comprises a normal inverting signal having sequentially distributed high levels and low levels in a first operating mode, and a scramble inverting signal having randomly distributed high levels and low levels in a second operating mode.

9. The method of claim 8, wherein the outputting the inversion control signal of the present frame comprising:
generating a scramble enable signal by comparing the previous frame data and the present frame data; and
selectively outputting one of the normal inverting signal and the scramble inverting signal based on the scramble enable signal.

10. The method of claim 9, wherein the scramble enable signal is generated when the previous frame data is different from the present frame data and a counter signal representing an accumulated status of polarity of the pixel voltage is unbiased.

11. The method of claim 8, wherein duration of the high levels and duration of the low levels maintain to be substantially the same.

12. A display apparatus comprising:
an inversion controlling part configured to compare a previous frame data and a present frame data to output an inversion control signal;
a data driver configured to generate a positive pixel voltage and a negative pixel voltage based on the inversion control signal; and
a display panel configured to display an image based on the positive pixel voltage and the negative pixel voltage.

13. The display apparatus of claim 12, wherein the inversion control signal comprises an inversion mode signal, the inversion mode signal including a column inversion mode signal and a dot inversion mode signal, the dot inversion mode signal including one dot inversion mode signal, two by one dot inversion mode signal, two by two dot inversion mode signal, three by one dot inversion mode signal and three by two dot inversion mode signal.

14. The display apparatus of claim 13, wherein when the previous frame data and the present frame data represent a moving artifact pattern, the inversion controlling part is configured to output the inversion mode signal including the dot inversion mode signal, and
when the previous frame data and the present frame data do not represent the moving artifact pattern, the inversion controlling part is configured to output the inversion mode signal including the column inversion mode signal.

15. The display apparatus of claim 14, wherein the display panel comprises a non-alternating pattern in which all subpixels in a first subpixel column are connected to a data line, and
wherein, when a pattern between the previous frame data and the present frame data is shifted by odd number of pixels in a row direction, the pattern is determined as the moving artifact pattern.

16. The display apparatus of claim 15, wherein the inversion controlling part compares grayscale voltages of one data line in the previous frame data and grayscale voltages of one data line in the present frame data.

17. The display apparatus of claim 12, wherein the inversion control signal comprises a normal inverting signal having sequentially distributed high levels and low levels in a first operating mode and a scramble inverting signal having randomly distributed high levels and low levels in a second operating mode.

18. The display apparatus of claim 17, wherein the inversion controlling part comprising:
a scramble signal generating part configured to generate a scramble enable signal by comparing the previous frame data and the present frame data; and
an inverting signal outputting part configured to selectively output one of the normal inverting signal and the scramble inverting signal based on the scramble enable signal.

19. The display apparatus of claim 18, wherein the scramble signal generating part is configured to generate the scramble enable signal when the previous frame data is different from the present frame data and a counter signal representing an accumulated status of polarity of the pixel voltage is unbiased.

20. The display apparatus of claim 18, wherein the inverting signal outputting part comprises a multiplexer, the multiplexer configured to receive the scramble enable signal as a control signal and the normal inverting signal and the scramble inverting signal as input signals and configured to output one of the normal inverting signal and the scramble inverting signal.
